(19) United States
(12) Patent Application Publication
(10) Pub. No.: US 2023/0088703 A1
(43) Pub. Date: Mar. 23, 2023

(54) APPARATUS AND METHOD FOR COLLECTING, COMBINING, AND APPLYING MICRO INGREDIENT FORMULATIONS TO PRODUCTS FOR HUMAN CONSUMPTION

(71) Applicant: CHALKRIDGE HOLDINGS INC., Vancouver (CA)

(72) Inventor: Ryan Brown, Vancouver (CA)

(73) Assignee: CHALKRIDGE HOLDINGS INC., Vancouver (CA)

(21) Appl. No.: 17/947,308

(22) Filed: Sep. 19, 2022

Related U.S. Application Data
(60) Provisional application No. 63/246,243, filed on Sep. 20, 2021.

(51) Int. Cl. B05B 5/16; B05B 5/025; B05B 5/035; B05B 5/053; A23L 33/105

(52) U.S. Cl. CPC B05B 5/1683; B05B 5/0255; B05B 5/035; B05B 5/0533; A23L 33/105; A23V 2002/00

(57) ABSTRACT

Apparatus and methods for precise measurement, dispensation and application of organic compounds, in particular cannabis-derived additives, to products for human consumption. The apparatus comprises a combination apparatus comprising one or more reservoirs containing the additives and a dispensing assembly operative to transfer the additives from the one or more reservoirs in precisely controlled quantities. The additives may be liquid or powdered. The apparatus further comprises an application apparatus for applying the measured additive to a dosing target. The application apparatus includes a first electrostatic charging device in operative connection to the dosing target and a second electrostatic charging device of an opposite polarity charge in operative connection with the additives, such that the additives are attracted to the dosing target.

This application claims priority to U.S. Provisional Patent Application No. 63/246,243, filed on 20 Sep. 2021, the specification of which is hereby incorporated herein by reference.

### FIELD OF THE INVENTION

This invention relates to precision measurement, dispensation, and application of organic substances to organic products for human consumption. In particular, this invention relates to method and apparatus for precisely measuring, dispensing, and combining of cannabis-derived additives and applying the combined additives to a product for human consumption.

### BACKGROUND OF THE INVENTION

Cannabis is principally harvested for its cannabinoid compounds (excepting those plant strains which are cultivated for fiber production, more commonly known as hemp). Cannabinoids include a diverse array of compounds. The principal compounds of interest are tetrahydrocannabinol (THC) and cannabidiol (CBD), but other commonly sought cannabinoids include, but are not limited to cannabigerol (CBG) and cannabinol (CBN). THC is principally consumed recreationally for its psychotropic effects, whereas CBD can be used to treat, or shows promise in treating, a variety of maladies. The effective or psychoactive dose of cannabinoids tends to be quite small, often on the order of several milligrams.

Another class of compounds of interest in cannabis is the terpenes. Terpenes are aromatic compounds that impart characteristic smells and flavours to cannabis. For example, limonene imparts smells commonly associated with citrus. Certain strains of cannabis are desirable not only for the relative concentrations of cannabinoids but for the smell and flavour imparted by its specific blend of terpenes. Additionally, terpenes may play a role in the effects and the potential health benefits of consumption of cannabinoids.

Cannabinoids and terpenes are most concentrated in the hairlike glandular trichomes that grow from the cannabis flower. Trichomes are delicate structures and may break off or exude a resinous substance rich in both classes of compounds with relatively gentle handling. Both classes of compounds may also be present in the stems and leaves of the cannabis plant, but will generally be significantly less concentrated there.

Production of cannabinoids in the trichomes is dependent on both the particular is strain of cannabis plant and on growing conditions, including, but not limited to, type of light, soil conditions, humidity, and temperature. Therefore, although a given strain may generally offer the desired ratio of the various cannabinoids, the actual concentrations may vary according to the region and harvest date. Even amongst crops harvested at the same time and place, there may be some variance in the cannabinoid concentrations. As the effective dose for most cannabinoids is quite small, having even slight variance is not ideal. Accordingly, it would be advantageous if the cannabis flower could be augmented with small amounts of cannabinoid or terpene concentrates in order to produce an end product which consistently meets a desired outcome, whether that be physiological effects for treatment of maladies or psychotropic effects for recreational use.

Further, a particular strain of cannabis plant may produce the desirable blend of cannabinoids but may also produce terpenes with less desirable characteristics, such as a “skunky” odour. It would therefore be advantageous if the cannabis product could be augmented with more desirable terpenes, or even non-cannabis derived flavouring agents.

Additionally, even if a harvest has the desired cannabinoid concentrations, processing of the cannabis plant and flower may dislodge trichomes from the flower, resulting in a less potent end product. Accordingly, it would be advantageous if cannabinoid extracts could be applied to the cannabis flower in order to make up for naturally occurring cannabinoids lost during processing.

Further still, cannabis plants are harvested primarily for the flower, where the trichomes and cannabinoids are most highly concentrated. This results in large amounts of leaf and stem material potentially being unused and wasted. This waste material, although being largely inferior to the flower in terms of cannabinoid and terpene content, still contains some cannabinoids. Accordingly, it would be advantageous if the waste material could be treated to improve its cannabinoid concentrations to be commercially viable, leading to less waste.

While smoking of the cannabis flower remains one of the more common methods of ingesting cannabinoids, the cannabinoids may also be extracted from the cannabis flower and ingested through other means. Such other means may include, but are not limited to, topical creams and ointments, edible products and confectioneries such as gummies and chocolate, and vaporizers. These products would also benefit from accurate and precise dosing, blending, and application of the cannabinoid extracts to the carrier substance.

It is therefore an object of this invention to provide a method and apparatus for selection, precision measuring, combining, and application of cannabinoid extracts to various target items.

It is a further object of the invention to provide for accurate and customizable application of mixtures of cannabinoids, terpenes, and/or other additives to cannabis flower, the application and binding of the mixture to the flower occurring through electrostatic attraction.

These and other objects will be better understood by reference to this application as a whole. Not all of the objects are necessarily met by all embodiments of the invention described below or by the invention defined by each of the claims.

### BRIEF SUMMARY OF THE INVENTION

One aspect of the invention generally provides apparatus and methods for applying additives, in particular cannabis-derived additives, to items intended for human consumption, such as cannabis flowers that are consumed through smoking, edible products, and topical products. The apparatus generally comprises two sub-assemblies.

A first sub-assembly comprises a dosing or combining apparatus. The dosing apparatus includes one or more reservoirs for storing one or more different additives and one or more dispensing mechanisms for extracting desired amounts of additives from the one or more reservoirs. The additives may be in a liquid or powdered format. In some embodiments comprising a plurality of the reservoirs, the dosing apparatus includes a mixing chamber for combining the different additives. In some embodiments, the dosing apparatus includes a computer processor and memory that stores various recipes for different combinations of additives. The recipes include instructions that when executed by the computer processor may cause the one or more dispensing mechanisms to alternately move between the reservoirs and dispense the additive in a desired quantity from the respective reservoir to the mixing chamber.

A second sub-assembly comprises an application apparatus. The application apparatus includes a target chamber for containing the consumable item and a dispenser for applying the additives to the consumable item. The application apparatus preferably includes a first electrostatic charging device that imparts a first electrostatic charge to the consumable item and a second electrostatic charging device that imparts a second electrostatic charge to the additives as they pass from the dispenser. The first electrostatic charge is of opposite polarity to the second electrostatic charge so that the additives are attracted to the consumable item.

In one aspect, the invention is an apparatus for applying additives to an organic substance. The organic substance may be any substance for human consumption, including by inhalation, ingestion, or topical application. The apparatus includes a target chamber for containing the organic substance while the additives applied. The apparatus includes one or more reservoirs containing one or more types of additives. A dispensing means is operable to transfer the additives from the one or more reservoirs, optionally into a mixing chamber for combining the different additives. An applicator means transfers the additives from the dispensing means, optionally via the mixing chamber, and applies the additives to the organic substance. The apparatus may optionally include a first charging means that applies a first electrostatic charge to the organic substance. The first charging means may be an electrode in contact with the organic substance. The apparatus may optionally include a second charging means that applies a second electrostatic charge to the additive before, during or after the applicator means. The second electrostatic charge is opposite in charge to the first electrostatic charge, such that the additives are attracted to and adhere to the organic substance.

In one aspect, the invention comprises a combining apparatus to store, dispense, and blend various additive substances. The combining apparatus comprises an enclosure and a plurality of syringes retained in the enclosure. Each syringe preferably comprises a barrel and a plunger. The barrel of each syringe preferably contains a dosing fluid comprising a carrier liquid and a defined concentration of a substance selected from the group consisting of a cannabinoid distillate, a terpene distillate, and a non-cannabis additive. The non-cannabis additive may comprise any substance derived from a source other than a cannabis plant, including but not limited to flavouring agents, nutritive supplements, preservatives, and the like. The plurality of syringes is preferably retained by the enclosure in a linear array. A first linear actuator is positioned adjacent to the plungers of the plurality of syringes and is longitudinally aligned with the linear array of the plurality of syringes. The first linear actuator moves a dosing assembly back and forth along the linear array of the plurality of syringes. The dosing assembly comprises a stepper motor which drives a second linear actuator. A paddle is mounted to the second linear actuator. The second linear actuator extends the paddle towards the plunger of the syringe it is currently positioned proximate to. Once the paddle contacts the plunger, the stepper motor precisely extends the paddle on the second linear actuator further to depress the plunger, which in turn expels the desired dose of fluid from the barrel to a collection chamber. By alternately moving the dosing assembly on the first linear actuator from one syringe to another and depressing the plunger associated with that respective syringe, a combination of dosing fluids will be created in the collection chamber. The collection chamber may further comprise mechanisms for combining or blending the combination of dosing fluids into a substantially homogeneous dosing mixture.

Each of the plurality of syringes is preferably removable from the enclosure for refilling or for replacement of one kind of dosing fluid with another. In some embodiments, the plurality of syringes may be retained in the enclosure by a syringe cartridge, which allows for removal and replacement of the entire plurality of syringes at once. This allows for rapid changes in the dosing fluids.

In some embodiments, some or all of the syringes may further comprise temperature control elements to maintain the dosing fluid at a desired temperature. The temperature control elements may maintain the dosing fluid at an elevated temperature, for example to decrease the viscosity of some dosing fluid varieties. The temperature control elements may maintain the dosing fluid at a reduced temperature, for example to increase the longevity of certain perishable dosing fluids.

In some embodiments, the plurality of syringes may be arranged in a rectangular array. Each row of syringes in the rectangular array may be associated with a first linear actuator and dosing assembly.

In other embodiments, the plurality of syringes may be arranged in a rectangular array but rather than each row of syringes being associated with its own first linear actuator and dosing assembly, a single first linear actuator and dosing assembly is mounted to a gantry. The gantry moves the first linear actuator and dosing assembly laterally between adjacent rows of syringes.

In some embodiments, the dosing assembly may remain stationary and the plurality of syringes may be moved into position beneath the dosing assembly for is dispensing of the respective fluid contained in each of the syringes of the plurality of syringes. The plurality of syringes may be retained in a rotary carousel. The plurality of syringes may be retained on a conveyor

In some embodiments, movement of the first linear actuator and dosing assembly is controlled by computer. A memory associated with the computer stores a plurality of recipes. Each recipe is associated with a certain combination of dosing fluids and comprises a set of instructions for operating the first linear actuator and dosing assembly in order to create that specific combination of dosing fluids. When a recipe is recalled by a user through a user interface associated with the computer, the computer executes the instructions, causing the dosing assembly to alternately move between syringes and depress the plunger of an indicated syringe with the paddle, thereby creating the specific combination of dosing fluids in the collection chamber.

In some embodiments, the user interface may allow a user to directly control the combination of dosing fluids by selecting the individual types and quantities of dosing fluids rather than following a pre-stored recipe.

In another aspect, the invention comprises a delivery apparatus that applies the combination of dosing fluids to a dosing target. Dosing targets may include, but are not limited to, cannabis flowers. According to some embodiments, the delivery apparatus comprises a dosing chamber into which the dosing target is introduced. The dosing target is coupled to a first electrode. An atomizing nozzle within the dosing chamber is directed towards the dosing target and connected to the collection chamber. The atomizing nozzle is coupled to a second electrode. The collection chamber is operatively connected to a pneumatic ram. The first and second electrodes are connected to a high voltage generator. By energizing the high voltage generator, the atomizing nozzle and dosing target are given strong opposite electric charges. The carrier fluids associated with each of the plurality of syringes are preferably volatile.

According to some embodiments, a method for applying a combination of dosing fluids to a dosing target comprises first dispensing a combination of dosing fluids from the plurality of syringes into the collection chamber as previously described. Next, the high voltage generator applies a strong electrical potential difference between the first and second electrodes. Then, the pneumatic ram acts upon the collection chamber to drive the combination of dosing fluids from the collection chamber through the atomizing nozzle. The atomizing nozzle produces a fine dosing mist that enters the dosing chamber. As the dosing mist passes from the atomizing nozzle, the small droplets are given a strong electrical charge due to the connection of the second electrode to the atomizing nozzle. Due to the connection between the first electrode and the dosing target, the dosing target is given a strong opposite electrical charge to that of the small droplets of the dosing mist. Accordingly, the dosing mist is attracted to the dosing target. As the volatile carrier fluid evaporates, the entrained compounds adhere to the dosing target without the need for the dosing target to be charged. As a result, the dosing target is resiliently coated with a thin layer of the desired compounds.

Forcing the combination of dosing fluids through the atomizing nozzle generally results in satisfactory combining of the plurality of dosing fluids comprising the combination of dosing fluids. However, for some applications, additional combining may be required. According to some embodiments, the collection chamber may further comprise various combining apparatus known in the art, including, but not limited to, agitators, sonication probes, stirring rods, and the like.

In some embodiments, the adhesion of the combination of dosing fluids to the dosing target may be unnecessary, such as when the dosing target is also a fluid. Fluid dosing targets may include, but are not limited to, topical preparations such as ointments and creams, beverages, e-cigarette liquids, and various confectioneries in a mid-production liquid state, such as melted chocolate and liquid gummy preparations. Where adhesion is unnecessary, then the delivery apparatus may comprise an enclosure and a dispensing nozzle connected to the collection chamber and aimed toward the dosing target. The enclosure may further comprise combining apparatus for thoroughly dispersing the combination of dosing fluids into the dosing target. The enclosure may further comprise heating apparatus to prevent premature solidification of the dosing target or to allow for cooking and baking processes of the dosing target following introduction of the combination of dosing fluids, e.g. to produced baked confectioneries. The enclosure may further comprise refrigerative apparatus to prevent liquefaction of the dosing target or promote solidification of the dosing target, for example gelling gummies.

Another aspect of the invention provides an apparatus for applying powdered cannabis-derived additives to a product for human consumption. The apparatus comprises a hopper containing a powdered cannabis-derived additive, a gravimetric dispensing device in operative connection with the hopper, the gravimetric dispensing device operative to dispense a predetermined quantity of the powdered additive to an accuracy within one milligram, a rotary tumbler for containing and tumbling the product, the rotary tumbler including a first electrostatic charging device for applying a first electrostatic charge to the product, an applicator assembly, the applicator assembly transferring the powdered additive from gravimetric dispensing device to the product in the rotary tumbler, and a second electrostatic charging device in operative connection with the applicator assembly for applying a second electrostatic charge to the powdered additive, wherein the first electrostatic charge is in opposite polarity to the second electrostatic charge.

In a further aspect, the applicator assembly may comprise a vibratory feeder.

In a further aspect, the first electrostatic charging device may comprise an electrode coupled to the applicator assembly.

In a further aspect, the product may be selected from the group consisting of cannabis flowers, cannabis leaves and stems, and food items.

In a further aspect, the powdered additives are selected from the group consisting of dried and ground cannabis, powdered cannabis extract, powdered cannabis distillate, sugar infused with cannabis extract, sugar infused with cannabis distillate, salt infused with cannabis extract, and salt infused with cannabis distillate.

Another aspect of the invention provides an apparatus for applying liquid cannabis-derived additives to a product for human consumption. The apparatus comprises a plurality of reservoirs, each reservoir containing a liquid additive, one or more volumetric dispensing devices, each of said one or more volumetric dispensing devices in operative connection with at least one of the plurality of reservoirs, each of the one or more volumetric dispensing devices operative to dispense a predetermined quantity of the liquid additives to an accuracy within one milliliter, a target chamber for containing the product, a nozzle in fluid communication with said one or more volumetric dispensing devices, the nozzle directed at the product in the target chamber, a first electrostatic charging device comprising a first electrode insertable in the product to apply a first electrostatic charge to the product, and a second electrostatic charging device comprising a second electrode in operative connection with the nozzle to apply a second electrostatic charge to liquid additives expelled from the nozzle, wherein the first electrostatic charge is opposite in polarity to the second electrostatic charge.

In a further aspect, each reservoir of said plurality of reservoirs may contain a different additive.

In a further aspect, the apparatus may include a mixing chamber connected between the one or more volumetric dispensing devices and the nozzle, the mixing chamber configured to combine additives from respective ones of the plurality of reservoirs.

In a still further aspect, each of the reservoirs may comprise a syringe and each of the one or more volumetric dispensing devices may comprise a linear actuator operable to depress a plunger of each respective syringe.

In a further aspect, the nozzle may be an atomizing nozzle.

In a further aspect, the product may be selected from the group consisting of cannabis flowers, cannabis leaves and stems, ingestible products, and topical products.

In a further aspect each liquid additive may comprise a carrier fluid and an additive selected from the group consisting of cannabis extracts, cannabinoid distillates, and terpene distillates.

Another aspect of the invention provides a method for applying a cannabis-derived additive to a product for human consumption. The method comprises dispensing component parts from one or more reservoirs within 1 mg accuracy, mixing the component parts to form the additive, applying a first electrostatic charge to the product, applying a second electrostatic charge to the additive, the second electrostatic charge being of opposite polarity to the first electrostatic charge, and subsequent to applying the second electrostatic charge to the additive, applying the additive to the product.

In a further aspect, at least one of the component parts may be selected from the group consisting of a cannabis extract, a cannabis distillate, a cannabinoid, and a terpene.

In a further aspect, each of the component parts may be a powder.

In a further aspect, each of the component parts may be suspended or dissolved in one or more carrier fluids, each one of the carrier fluids being miscible with the other carrier fluids.

In a still further aspect, the method may comprise storing each carrier fluid containing a different component part in a different respective syringe, each syringe in fluid communication with a mixing chamber, positioning a linear actuator over a first one of said syringes containing a first one of said component parts, actuating, by the linear actuator, a first plunger associated with the first one of said syringes to dispense a first amount of said first one of said component parts from said first one of said syringes into the mixing chamber, re-positioning the linear actuator over a second one of said syringes containing a second one of said component parts, actuating, by the linear actuator, a second plunger associated with the second one of said syringes to dispense a second amount of said second one of said component parts from said second one of said syringes into the mixing chamber, mixing the component parts in the mixing chamber to form the desired additive, and operating a ram to force the desired additive in the mixing chamber through a nozzle in fluid communication with the mixing chamber, the nozzle aimed to dispense the desired additive on the organic substance. Another aspect of the invention provides an apparatus for applying powdered cannabis-derived additives to a product for human consumption. The apparatus comprises one or more reservoirs, each of said one or more reservoirs containing a powdered cannabis-derived additive, one or more gravimetric dispensing devices, each of said one or more gravimetric dispensing devices in operative connection with at least one of said one or more reservoirs, a target chamber for containing the product, an applicator assembly, the applicator assembly transferring the powdered additive from the one or more gravimetric dispensing devices to the product in the target chamber, a first electrostatic charging device in operative connection with the applicator assembly for applying a first electrostatic charge to the powdered additive, and a second electrostatic charging device in operative connection with the product for applying a second electrostatic charge to the product. The first electrostatic charge is in opposite polarity to the second electrostatic charge.

According to a further aspect, each of the one or more gravimetric dispensing devices comprises a load cell and a conveyor coupled to each of said one or more reservoirs. The conveyor may comprise a screw conveyor. The conveyor may comprise a pneumatic conveyor.

According to a further aspect, the one or more gravimetric dispensing devices includes a mixing chamber, a load cell coupled to the mixing chamber, and a conveyor in operative connection with the mixing chamber and selectively movable among each of the one or more reservoirs. Each of the conveyors may comprise a screw conveyor. Each of the conveyors may comprise a pneumatic conveyor.

According to a further aspect, the applicator assembly may comprise a scarf plate feeder or a vibratory feeder pan. The applicator assembly may further include an air knife disposed at an end of the vibratory feeder pan.

According to a further aspect, the first electrostatic charging device may comprise an electrode coupled to the applicator assembly or an electric field generator disposed in the target chamber between the applicator assembly and the product.

According to a further aspect, the second electrostatic charging device comprises a charged tumbler disposed in the target chamber or an electrode insertable in the product.

According to a further aspect, the product is selected from the group consisting of cannabis flowers, cannabis leaves and stems, ingestible products, and topical products. The powdered additives are selected from the group consisting of dried and ground cannabis, powdered cannabis extract, powdered cannabis distillate, sugar infused with cannabis extract, sugar infused with cannabis distillate, salt infused with cannabis extract, and salt infused with cannabis distillate.

According to a further aspect, the apparatus comprises a product conveyor for transferring the product into and out of the target chamber.

According to a further aspect, the target chamber includes heating elements and/or cooling elements.

According to a further aspect, the one or more reservoirs comprises a plurality of reservoirs, each of said plurality of reservoirs containing a different additive.

According to a still further aspect, the apparatus includes a computer processor and memory, the memory storing instructions that when executed by the processor, cause the apparatus to selectively dispense, by the one or more gravimetric dispensing devices, additives from at least two of said plurality of reservoirs to form a compound additive, and apply, by the applicator assembly, the compound additive to the product. The apparatus may include a control panel from which a user can manually control the apparatus and edit the instructions stored in the memory. The apparatus may include network connectivity from which a user can remotely control the apparatus and edit the instructions stored in the memory.

Another aspect of the invention provides an apparatus for applying liquid cannabis-derived additives to a product for human consumption. The apparatus comprises one or more reservoirs, each reservoir containing a liquid additive, one or more volumetric dispensing devices, each of said one or more volumetric dispensing devices in operative connection with at least one of said one or more reservoirs, a target chamber for containing the product, and a nozzle in fluid communication with said one or more volumetric dispensing devices, the nozzle directed at the product in the target chamber.

According to a further aspect, the one or more reservoirs includes a plurality of reservoirs. Each reservoir of said plurality of reservoirs may contains a different additive.

According to a further aspect, the apparatus includes a mixing chamber connected between the one or more volumetric dispensing devices and the nozzle, the mixing chamber configured to combine additives from respective ones of the plurality of reservoirs. The mixing chamber may include a stirrer, a shaker, or a ball mill.

According to a further aspect, the one or more volumetric dispensing devices includes a dispenser movable among the plurality of reservoirs to selectively dispense the additive from a respective reservoir.

According to further aspect, the one or more volumetric dispensing devices includes a plurality of dispensers, each dispenser associated with a respective one of the plurality of reservoirs.

According to a still further aspect, each of the reservoirs comprises a syringe and each of the dispensers comprises a linear actuator operable to depress a plunger of each respective syringe. The linear actuator may include a stepper motor actuating a rack and pinion set or a ballscrew.

According to a further aspect, the apparatus includes a first electrostatic charging device in operative contact with the product. The first electrostatic charging device may comprise an electrode insertable in the product. The first electrostatic charging device may comprise a charged tumbler in the target chamber.

According to a further aspect, the nozzle is an atomizing nozzle.

According to a still further aspect, the apparatus includes a second electrostatic charging device in operative contact with the atomizing nozzle, wherein the first electrostatic charging device is in opposite polarity to the second electrostatic charging device.

According to a further aspect, the product is selected from the group consisting of cannabis flowers, cannabis leaves and stems, ingestible products, and topical products.

According to a further aspect, each liquid additive comprises a carrier fluid and an additive selected from the group consisting of cannabis extract, cannabinoid distillates, and terpene distillates. The carrier fluid may be an oil. The carrier fluid may be a volatile liquid and the additive is a powdered additive suspended in the volatile liquid.

According to a further aspect, the apparatus comprises a product conveyor for transferring the product into and out of the target chamber.

According to a further aspect, the target chamber includes heating elements and/or cooling elements.

According to a further aspect, the apparatus includes a computer processor and memory, the memory storing instructions that when executed by the processor, cause the apparatus to selectively dispense, by the one or more volumetric dispensing devices, additives from at least two of said plurality of reservoirs to form a compound additive, and apply, by the nozzle, the compound additive to the product. The apparatus may include a control panel from which a user can manually control the apparatus and edit the instructions stored in the memory. The apparatus may include network connectivity and a remote computer from which a user can remotely control the apparatus and edit the instructions stored in the memory.

Another aspect of the invention provides a method for applying a cannabis-derived additive to a product for human consumption. The method comprises dispensing component parts from one or more reservoirs within 1 mg accuracy, mixing the component parts to form the additive, applying a first electrostatic charge to the product, applying a second electrostatic charge to the additive, the second electrostatic charge being of opposite polarity to the first electrostatic charge, subsequent to applying the second electrostatic charge to the additive, applying the additive to the product.

According to a further aspect, at least one of the component parts is selected from the group consisting of a cannabis extract, a cannabis distillate, a cannabinoid, and a terpene.

According to a further aspect, each of the component parts is a powder.

According to a further aspect, each of the component parts is suspended or dissolved in one or more carrier fluids, each one of the carrier fluids being miscible with the other carrier fluids.

According to a further aspect, A method according to any one of the preceding claims wherein the product comprises cannabis flowers, a solid food item, a fluid item, a beverage, or a topical ointment, lotion, gel, unguent, or cream for application to a person's skin.

According to a still further aspect, the method comprises mixing the product to distribute the applied additive throughout the product.

According to a still further aspect, the method comprises heating or cooling the product.

According to a further aspect, the first electrostatic charge is applied to the product by a charged tumbler.

According to a further aspect, the first electrostatic charge is applied to the product by an electrode in contact with the product.

According to a further aspect, the first electric charge is applied to the product by triboelectric effect.

According to a further aspect, the method includes using an atomizing nozzle to apply the desired additive to the product.

According to a further aspect, the second electric charge is applied to the additive by an electrode in contact with the atomizing nozzle.

According to a further aspect, the method comprises storing each carrier fluid containing a different component part in a different respective syringe, each syringe in fluid communication with a mixing chamber, positioning a linear actuator over a first one of said syringes containing a first one of said component parts, actuating, by the linear actuator, a first plunger associated with the first one of said syringes to dispense a first amount of said first one of said component parts from said first one of said syringes into the mixing chamber, re-positioning the linear actuator over a second one of said syringes containing a second one of said component parts, actuating, by the linear actuator, a second plunger associated with the second one of said syringes to dispense a second amount of said second one of said component parts from said second one of said syringes into the mixing chamber, operating a ram to force the desired additive in the mixing chamber through a nozzle in fluid communication with the mixing chamber, the nozzle aimed to dispense the desired additive on the organic substance.

According to a further aspect, the method includes, prior to operating the ram, mixing the component parts in the mixing chamber, wherein mixing comprises at least one process selected from the group consisting of stirring, blending, milling, and agitating.

Another aspect of the invention provides an apparatus for coating cannabis flower. The apparatus includes a mixing assembly including a plurality of syringes, each syringe containing a fluid additive, one or more linear actuators, each of said one or more linear actuators selectively positionable in alignment with a respective plunger of each syringe, a paddle attached to a distal end of each said one or more linear actuators, each of said paddles and respective linear actuators operable to selectively depress the plunger of each respective syringe, a mixing chamber in fluid communication with each of said syringes, and a dosing assembly including a target chamber, a first electrode having a first polarity, the first electrode connectable to the cannabis flower, a nozzle in fluid communication with the mixing chamber, a second electrode having a second polarity, the second electrode connected to the nozzle, wherein the first polarity is opposite to the second polarity.

According to a further aspect, each fluid additive comprises a carrier liquid and a cannabis-derived compound. The carrier liquid may be an oil and the cannabis-derived compound may be selected from the group consisting of cannabis extracts, cannabinoid distillates, and terpene distillates. The carrier liquid may be a volatile liquid and the cannabis-derived compound may be a powdered cannabis extract suspended in the volatile liquid.

According to a further aspect, the mixing chamber includes a stirrer for combining the fluid additives communicated to the mixing chamber.

According to a further aspect, the nozzle is an atomizing nozzle.

According to a further aspect, the mixing chamber includes a ram to force fluid additives from the mixing chamber through the atomizing nozzle.

According to a further aspect, the target chamber including a rotary tumbler, the rotary tumbler in operative contact with the first electrode.

According to a further aspect, the apparatus includes a conveyor passing through the target chamber.

According to a further aspect, the target chamber includes heating elements and/or refrigerative elements.

According to a further aspect, the apparatus includes a computer processor and memory, the memory storing instructions that when executed by the computer processor cause the apparatus to move the linear actuator into alignment with a first one of said plurality of syringes, extend the paddle on the linear actuator to depress a plunger thereof to transfer a quantity of a first additive contained in said first one of said plurality of syringes into said mixing chamber, move the linear actuator into alignment with a second one of said plurality of syringes, extend the paddle on the linear actuator to depress a plunger thereof to transfer a quantity of a second additive contained in said second one of said plurality of syringes into said mixing chamber, energize said first and second electrodes, and energize said nozzle to coat a cannabis flower in said target chamber with a combination of said first and second additives.

The foregoing may cover only some of the aspects of the invention. Other and sometimes more particular aspects of the invention will be appreciated by reference to the following description of at least one preferred mode for carrying out the invention in terms of one or more examples. The following mode(s) for carrying out the invention are not a definition of the invention itself, but are only example(s) that embody the inventive features of the invention.

### BRIEF DESCRIPTION OF THE DRAWINGS

At least one mode for carrying out the invention in terms of one or more examples will be described by reference to the drawings thereof in which:

FIG. 1 is a perspective view of a dosing apparatus according to the invention comprising a combining apparatus and an application apparatus;

FIG. 2 is a detail perspective view of an embodiment of a combining apparatus according to the invention;

FIG. 3 is a block diagram of control components for the combining apparatus of FIG. 2;

FIG. 4 is a detail perspective view of the preferred embodiment of an application apparatus according to the invention;

FIG. 5 is a flowchart of a method for dosing a dosing target according to the invention;

FIG. 6 is a detailed flowchart of the steps indicated in FIG. 5 comprising a method of measuring and combining a compound dosing liquid according to the invention;

FIG. 7 is a detailed flowchart of the steps indicated in FIG. 5 comprising a method of applying a compound dosing liquid to a dosing target;

FIG. 8 is a perspective view of a second embodiment of the combining apparatus according to the invention comprising multiple syringe racks and dispensing apparatus;

FIG. 9 is a perspective view of a third embodiment of the combining apparatus according to the invention comprising multiple syringe racks and a single dispensing apparatus;

FIG. 10 is a perspective view of a fourth embodiment of the combining apparatus according to the invention comprising a syringe carousel;

FIG. 11 is a front view of a fifth embodiment of the combining apparatus according to the invention comprising a syringe conveyor;

FIG. 12 is a front view of a second embodiment of the application apparatus according to the invention adapted for fluid dosing targets;

FIG. 13 is a front view of another embodiment of a combining apparatus according to the invention including a dosing target conveyor;

FIG. 14 is a perspective view of another embodiment of a dosing apparatus according to the invention adapted for powdered additives;

FIG. 15 is a front view of an embodiment of an application apparatus adapted for powdered additives, showing an interior of a rotary tumbler; and

FIG. 16 is an exploded view of an embodiment of a dispensing apparatus adapted for powdered additives.

### DETAILED DESCRIPTION OF AT LEAST ONE MODE FOR CARRYING OUT THE INVENTION IN TERMS OF EXAMPLE(S)

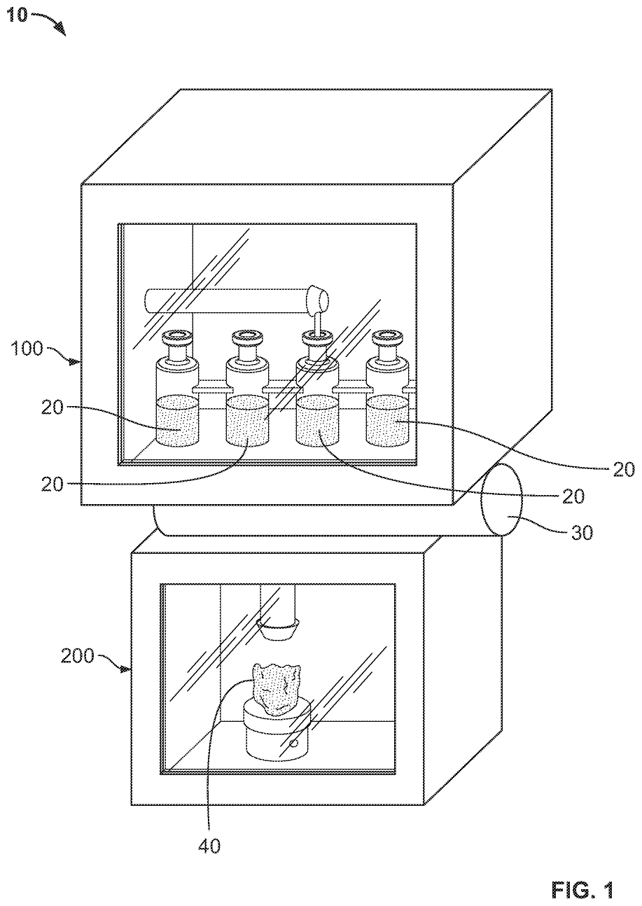

Referring to FIG. 1, according to an embodiment of the invention, a dosing apparatus 10 for liquid additives generally comprises a combining apparatus 100 for dispensing and mixing a plurality of differing dosing fluids 20 into a compound dosing liquid 30 and an application apparatus 200 for applying the compound dosing liquid 30 to a dosing target 40.

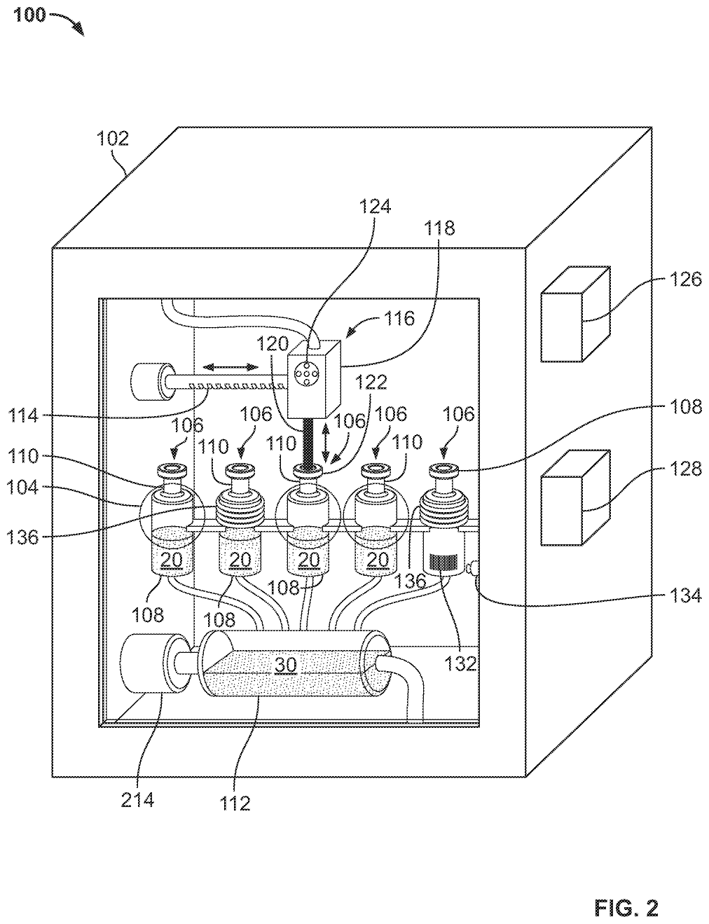

Referring to FIG. 2, according to a first embodiment of the invention, A combining apparatus 100 comprises an enclosure 102 and a syringe rack 104 retained within the enclosure 102. In some embodiments, a plurality of syringes 106 comprising the one or more reservoirs are coupled to the syringe rack 104. Each syringe 106 comprises a barrel 108 and a plunger 110. Each barrel 108 will preferably contain a different variety of dosing fluid 20. The dosing fluids 20 each generally comprise an active ingredient, such as a cannabinoid, and a carrier liquid, such as an oil. The dosing fluids 20 each may include, but are not limited to, a cannabinoid concentrate, a cannabinoid distillate, a terpene distillate, and a non-cannabis derived additive. Cannabinoid concentrates are generally oily liquids generated by an extraction process applied to the cannabis flower. Cannabinoid concentrates may thus contain one or more different varieties of cannabinoids, terpenes, and/or phytochemicals extracted from the cannabis flower. In contrast, cannabinoid and terpene distillates are cannabinoid concentrates that have been further processed through distillation processes and will thus generally contain only a single variety of cannabinoid or terpene. Cannabinoids may include, but are not limited to, tetrahydrocannabinol (THC), cannabidiol (CBD), cannabigerol (CBG), cannabinol (CBN), and cannabichromene (CBC) as well as acid forms of these compounds. Terpenes may include, but are not limited to, pinene, limonene, myrcene, caryophyllene, and terpinolene. Non-cannabis derived additives include, but are not limited to, flavoring agents, preservatives, and nutritional supplements. In some embodiments, the active ingredients are powdered and suspended in a volatile liquid. Each barrel 108 may contain a mixture of cannabinoids, terpenes, and/or non-cannabis derived additives, but it is preferable that each barrel contain only a single variety of these compounds so as to allow more control over the constituents of a compound dosing liquid 30 by the combining apparatus 100. Each syringe 106 is connected to a collection chamber 112 such that when the plunger 110 is depressed, the dosing fluid 20 is transferred from the barrel 108 to the collection chamber 112.

In some embodiments, a first linear actuator 114 is mounted within the enclosure 102 above the plungers 110 of the plurality of syringes 106 and runs longitudinally across the syringe rack 104. The first linear actuator 114 may be any type of linear actuator known in the art, including, but not limited to, pneumatic or hydraulic actuators, rack and pinion drives, leadscrews, ballscrews, and the like. It should be appreciated that the syringe rack 104 and syringes 106 could also be oriented horizontally, in which case the first linear actuator 114 would be oriented parallel to the syringe rack and adjacent to the plungers 110.

A dosing assembly 116 is coupled to the first linear actuator 114 for longitudinal movement between each syringe 106 of the plurality of syringes 106. In some embodiments, the dosing assembly 116 comprises a carriage 118 and a second linear actuator 120 mounted to the carriage. A paddle 122 is coupled to the second linear actuator 118 for movement towards and away from the plungers 110. A stepper motor 124 drives the second linear actuator 120 to allow for precise positioning of the paddle 122. By extending the paddle 122 against a plunger 110 in precisely controlled increments using the stepper motor 124, the plunger 110 may be depressed to dispense a precise amount of the dosing fluid 20 contained therein into the collection chamber 112, preferably with an accuracy of within 1 millilitre. Accordingly, the second linear actuator 120 may be any type of linear actuator known in the art but is preferably of the type that allows for precise positioning, such as a ballscrew. By alternately positioning the dosing assembly 116 to be aligned with different syringes 106 using the first linear actuator 114, and extending the paddle 122 against the plunger 110 of that syringe 106 to dispense the dosing fluid 20 contained therein into the collection chamber 112, the compound dosing liquid 30 is accumulated in the collection chamber 112. This compound dosing liquid 30 can then be extracted from the collection chamber 112 and either stored for later use or applied to various products as described in further detail below. The stepper motor 124 has generally been found to be precise enough to accurately dispense most dosing fluids 20 of interest while also being economic. However, it should be recognized that in certain applications, very high precision and accuracy may be required, and the stepper motor 124 may be substituted with a servomotor without departing from the spirit of the invention.

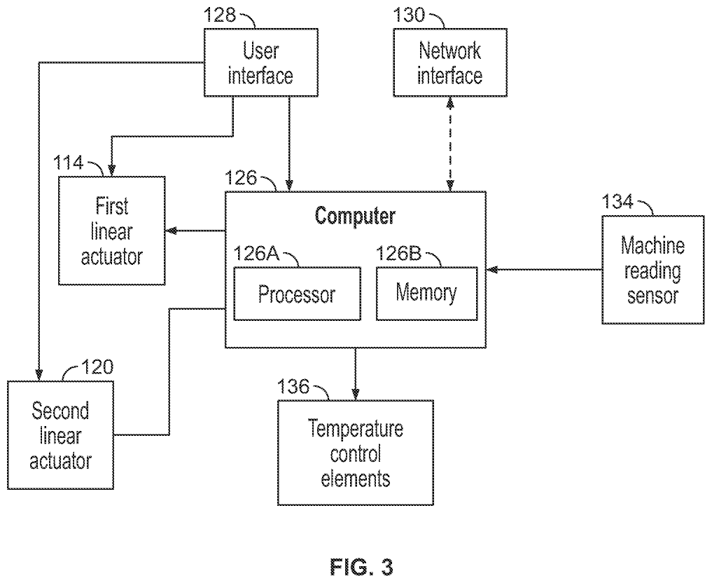

Referring to FIGS. 2 and 3, the combining apparatus 100 preferably further comprises a computer 126 and user interface 128 operatively connected to the dosing assembly 114. The computer 126 comprises a processor 126A and memory 126B. The memory 126B stores identifying information related to the dosing fluid contained in each syringe 106. The identifying information preferably comprises the type and concentration of the active ingredient of the dosing fluid 20 and the amount of dosing fluid 20 remaining in the respective syringe 106. The memory 126B also stores a plurality of compound dosing liquid recipes. Each recipe contains a set of instructions that, when executed by the processor, sequentially moves the dosing assembly 114 to dispense the constituent dosing fluids 200f the compound dosing liquid 30 associated with the recipe into the collection chamber 112. The recipe may comprise optimizations so that the order in which the dosing fluids 20 are dispensed are selected to minimize the amount of movement of the dosing assembly 114 in order to produce the compound dosing liquid 30.

The user interface 128 may comprise any common apparatus known that allows information to be displayed to a user and accepts inputs from the user, including but not limited to, a keypad and display or touchscreen. The user interface 128 allows the user to select a recipe stored in the memory 126B of the computer and cause the processor 126A to execute the recipe. The user interface 128 may also display the identifying information associated with each syringe 106 to the user. The user may also enter new recipes into the memory 126B through the user interface 128. The user interface 128, by itself or in conjunction with the computer 126, may also allow a user to directly control the dosing assembly 114 to move between syringes 106 and extend the paddle 118 to dispense the user's desired amount of the dosing fluid 20 contained in a particular syringe 106. Through the user interface 128, the user can therefore manually create a compound dosing liquid 30 of the user's choice.

The computer 126 may further comprise a network interface 130 that allows users to remotely select recipes or control the dosing assembly directly, for example through a website or a mobile phone app. This would allow, as a non-limiting example, a doctor to transmit a prescription comprising a particular compound dosing liquid 30 to the combining apparatus in a dispensary or pharmacy for fulfillment. As another example, a retailer could remotely input a recipe for a wholesale order of product comprising the compound dosing liquid 30.

Each syringe 106 may comprise machine-identifiable markings 132, such as, but not limited to, a bar code. The machine-identifiable markings 132 encode identifying information relating to the type and concentration of the active ingredient, and total volume of the dosing fluid 20 contained in the syringe 106. The enclosure may further comprise one or more machine-reading sensors 134, such as, but not limited to, a barcode scanner, that can read and decode the machine-identifiable markings 132 on each of the syringes 106. This allows the combining apparatus 100 to automatically update the identifying information stored in the memory 126B of the computer 126 when, a syringe 106 is replaced by a syringe containing a different dosing fluid for executing different recipes.

In some embodiments, collection chamber 112 is removable from enclosure 102. Removable collection chambers 112 may store sufficient compound dosing liquid 30 to dose a single dosing target 40. Multiple collection chambers 112 may be filled with a particular recipe, removed from enclosure 102, and stored for later use. When a particular recipe is desired, a collection chamber 112 containing the prepared compound dosing liquid 30 corresponding can be installed back in enclosure 102 and applied instantly to the dosing target 40. This allows, for example, a stock of popular recipes to be stored in multiple collection chambers 112 in advance rather than needing to create the compound dosing liquid 30 each time. In some embodiments, removable collection chambers 112 may be disposable. In some embodiments, removable collection chambers 112 may be made from a resilient, reusable material such as glass or stainless steel, which can be washed and used to store compound dosing liquid 30 according to different recipes.

The enclosure 102 may further comprise one or more temperature control elements 136 associated with some or all of the plurality of syringes 106. The temperature control elements 136 may comprise heating elements or refrigerating elements. Heating elements may be necessary to, for example, maintain certain dosing fluids in a liquid state. Refrigerating elements may be necessary to, for example, prevent spoilage of certain dosing fluids. The plurality of temperature control elements 136 may comprise a mixture of heating elements and cooling coils as required for the assortment of dosing fluids in the syringes 106. The computer 126 preferably also controls operation of the temperature control elements 136 as shown in FIG. 3.

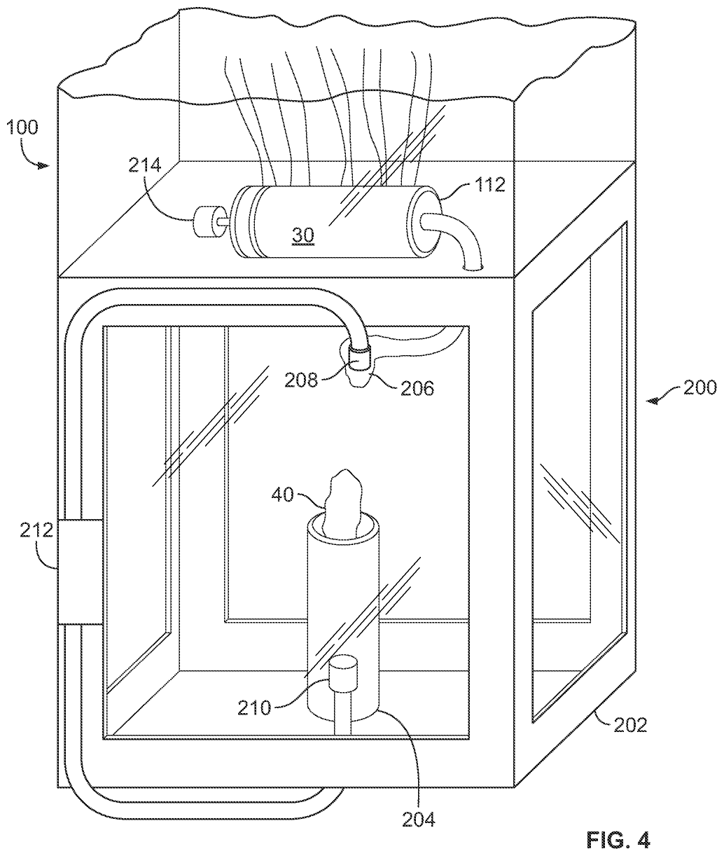

Referring to FIG. 4, in another aspect the invention comprises an application apparatus 200. According to the preferred embodiment, the application apparatus 200 comprises a compartment 202 and a target platform 204 within the compartment 202. The dosing target is placed within the compartment 202 on the target platform 204. An atomizing nozzle 206 is operatively connected to the collection chamber 112 of the combining apparatus 100. A first electrode 208 is connected to the atomizing nozzle 206 and a second electrode 210 is connected to the target platform 204. A high voltage generator 212 is operatively connected the first and second electrodes 208, 210. When the high voltage generator 212 is energized, a strong electric charge is applied to the first electrode 208 and through the first electrode 208 to the atomizing nozzle 206. A strong opposite electric charge is applied to the second electrode 210 and through the second electrode 210 to the dosing target 40. In the preferred embodiment, the dosing target 40 is generally any solid organic object for human consumption for which it is desirable to apply a thin, uniform coating of the ingredients in the compound dosing liquid 30. Non-limiting examples may include cannabis flower, fresh or dried fruit, confectioneries, cheeses, and the like.

A pneumatic ram 214 is operatively connected to the collection chamber 112. The pneumatic ram 214 drives the compound dosing liquid 30 from the collection chamber 112 and through the atomizing nozzle 206, where it enters the compartment 202 as a very fine mist.

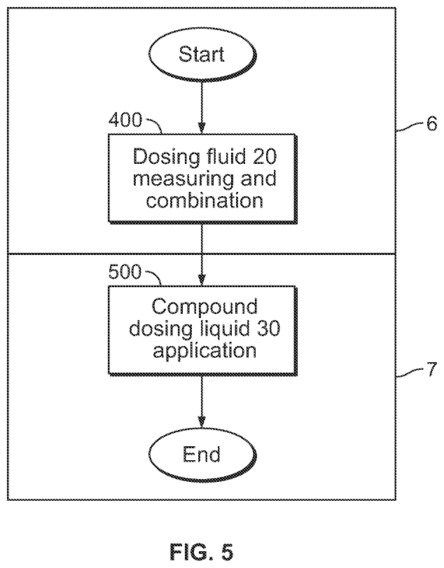

Referring to FIGS. 5-7, a method for applying a thin coating of compound dosing liquid 30 to a dosing target 40 using the dosing apparatus 10 comprises the steps of dosing fluid measurement and combination 400 and compound dosing liquid application 500. Dosing fluid measurement and combination 400 is primarily carried out by the combination apparatus 100, while compound dosing liquid application 500 is primarily carried out by the application apparatus 200.

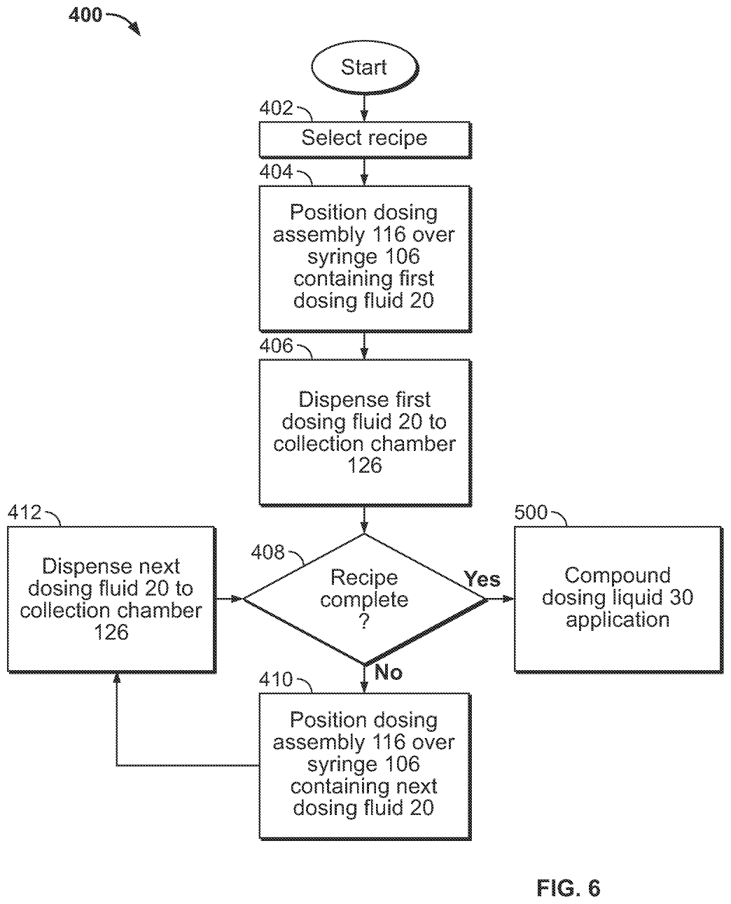

FIG. 6 is a flow chart representing a set of operations comprising the dosing fluid measurement and combination 400 process. Each of the operations may be carried out by the user through the user interface 128 or automated by the computer 126. At step 402, the user selects a recipe representing a desired compound dosing liquid 30 to augment their desired dosing target 40. At step 404, the dosing assembly 116 is positioned over the syringe 106 containing a first dosing fluid 20 that is a component of the desired compound dosing liquid 30. At step 406, the paddle 118 is extended against the plunger 110 of the syringe 106 to dispense the required amount of the first dosing fluid 20 into the collection chamber 112. At step 408, the recipe is reviewed to determine if all of the required dosing fluids have been dispensed into the collection chamber. If not, at step 410 the dosing assembly 116 is re-positioned over the syringe 106 containing the next dosing fluid 20 and at step 412 the paddle is again extended against the plunger 110 of the next syringe 106. Steps 408-410 are repeated until all of the dosing fluids specified by the recipe have been dispensed to the collection chamber 112. The collection chamber 112 now contains the desired compound dosing liquid, and the compound dosing liquid application 500 process may be initiated. Alternatively, the compound dosing liquid 30 may be extracted from the collection chamber 112 and stored for future use.

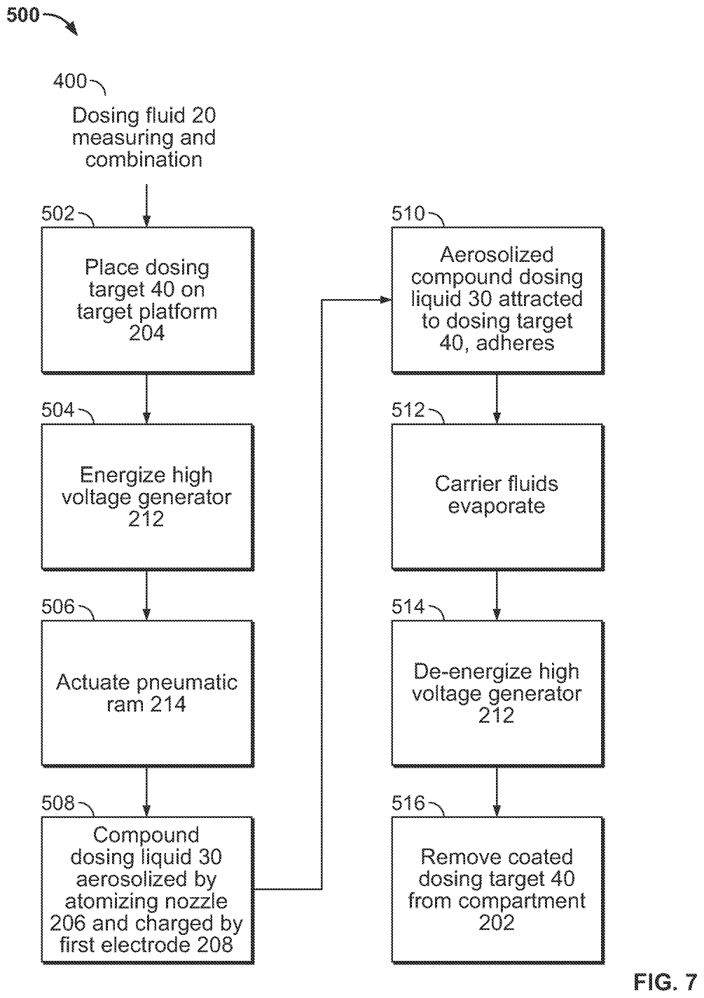

FIG. 7 is flow chart representing a set of operations comprising the compound dosing liquid application 500 process. As with the dosing fluid measurement and combination 400 process, these operations may be carried out by the user or automated by the computer 126. However, with the exception of steps 502 and 516, the compound dosing liquid application 500 process generally always comprises the same steps which may be performed by the application apparatus 200 and is thus well suited to automation. At step 502, the desired dosing target 40 is placed on the target platform 204 and electrical coupling of the dosing target with the second electrode 210 is ensured. At step 504, the high voltage generator 212 is energized, thereby charging the first electrode 208 and oppositely charging the second electrode 210, which in turn oppositely charges the dosing target 40.

At step 506, the pneumatic ram 214 is actuated to expel the compound dosing liquid 30 from the collection chamber 112 under pressure. At step 508, the compound dosing liquid 30 passes through the atomizing nozzle 206 and is aerosolized in the compartment 202. Simultaneously, the compound dosing liquid 30 mist is charged by the first electrode 208. At step 510, the charged compound dosing liquid 30 mist is attracted to the oppositely-charged dosing target 40, where it adheres due to electrostatic cling. At step 512, the carrier fluid of the compound dosing liquid 30 is allowed to evaporate, thereby forming a thin active ingredient coating on the dosing target. At step 514, the high voltage generator 212 is de-energized, which allows the dosing target 40 to be safely removed from the compartment 202 at step 516.

Given the wide variety of recipes and dosing fluids 20 possible, it will not be feasible to store dosing fluids 20 for all possible recipes in the enclosure 102 at the same time. Additionally, syringes 106 will need to be refilled once empty, and it is preferable that the refilling be accomplished outside of the enclosure 102. Therefore, the invention includes features that allow for easy and rapid removal and replacement of the syringes 106. In some embodiments, the syringes 106 are releasably retained in the syringe rack 104, for example by straps, bayonet style connections, clamps, and the like. In some embodiments, the syringe rack 104 is releasably retained in the enclosure to allow for multiple syringes 106 to be removed and replaced at once.

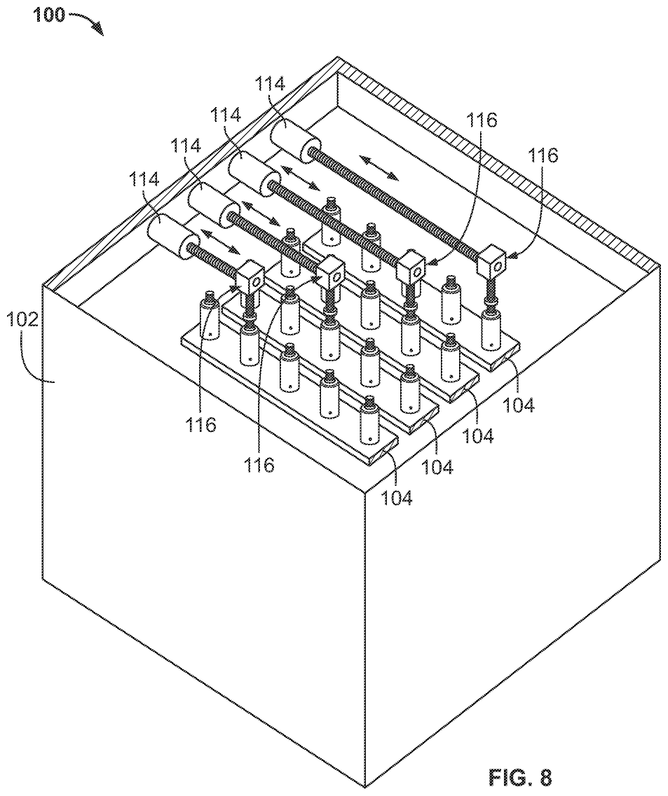

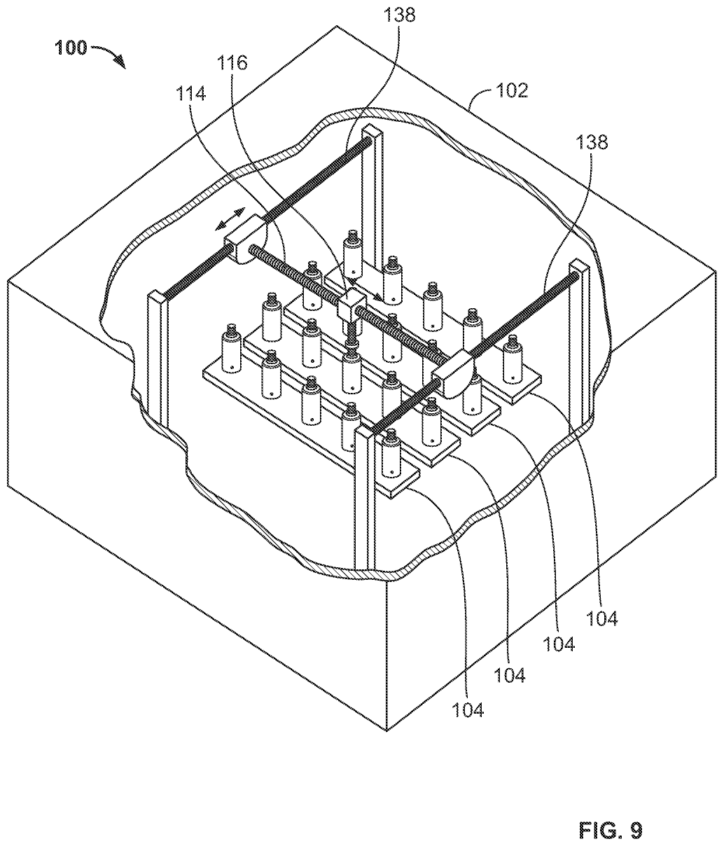

Referring to FIGS. 8 and 9, according to another embodiment of the invention a plurality of syringe racks 104 and respective dosing assemblies 116 and first linear actuators 114 may be arrayed laterally in the enclosure 102. Multiple syringe racks 104 and dosing assemblies 116 will increase the cost of the combination apparatus 100, but will also increase capacity for different dosing fluids 20 and allow for dispensing a plurality of dosing fluids 20 to the collection chamber simultaneously 112, thereby improving the speed of the combination apparatus 200. In another embodiment, the enclosure 102 comprises a plurality of syringe racks 104 but a single dosing assembly 116. The first linear actuator 114 and dosing assembly 116 are mounted on a gantry 138. The gantry 138 translates in the enclosure 102 perpendicularly to the first linear actuator 114. The gantry 138 therefore can reposition the dosing assembly 116 laterally between adjacent syringe racks 104.

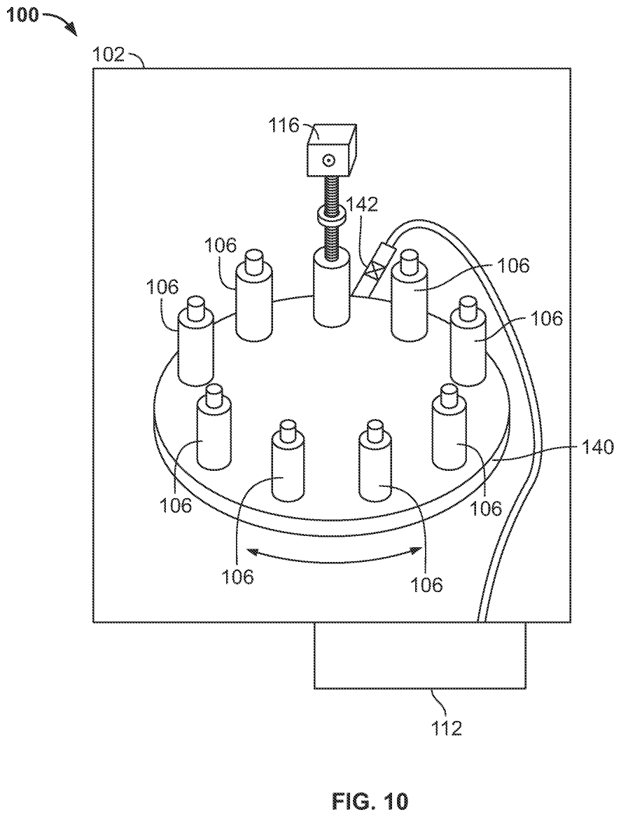

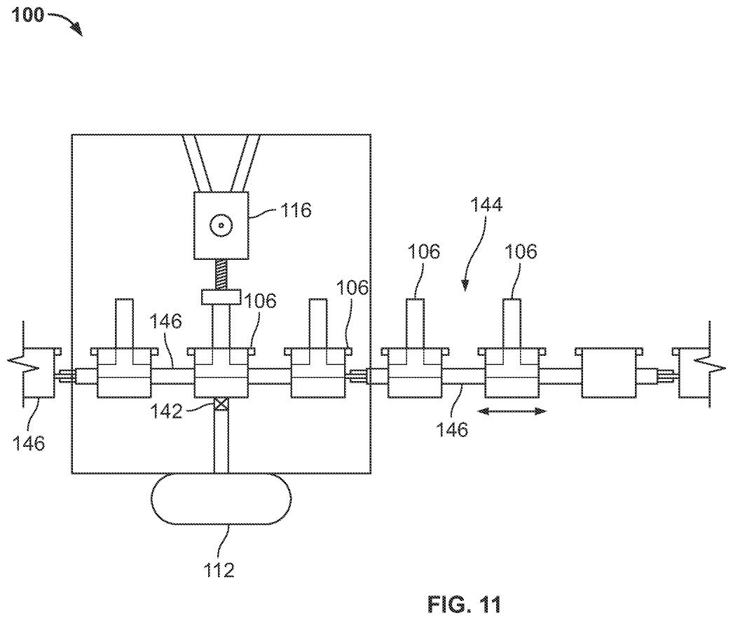

Referring to FIGS. 9 and 10, according to another embodiment of the invention, the dosing assembly 116 is fixed to the enclosure 102. The syringes 106 are retained by a rotary carousel 140. By rotating the carousel 140, a desired syringe is brought into alignment with the dispensing assembly 116 and a port 142 communicatively connected to the collection chamber 112.

In some embodiments, a carousel 140 capable of storing all of the dosing fluids necessary for the desired recipes would be inconveniently large. Instead, the syringes are retained on a conveyor rack 144 that can rapidly cycle syringes 106 into and out of the enclosure 102. The conveyor rack 144 generally comprises a plurality of rack segments 146 hingedly connected in a loop. Each rack segment 146 may retain one or more syringes 106.

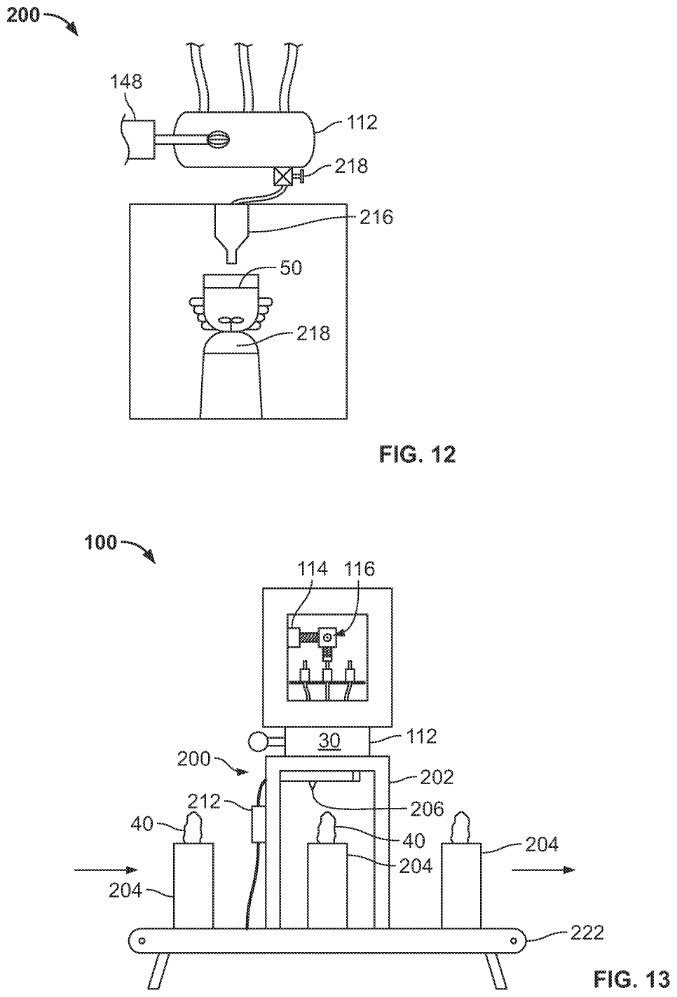

Referring to FIG. 12, for many applications, the process of driving the compound dosing liquid 30 through the atomizing nozzle 206 under pressure from the pneumatic ram 214 sufficiently mixes the compound dosing liquid 30. However, in some embodiments, the collection chamber 112 further comprises a mixing device 148. The mixing device 148 may be any well-known device for mixing liquids, including, but not limited to, stirring rods, agitators, sonicators, and the like. The mixing device 148 serves to combine the dosing fluids to produce a compound dosing liquid 30 to a desired degree of homogeneity.

In some embodiments, the dosing target may comprise a target fluid 50, in which case the compound dosing fluid 30 may be incorporated throughout the dosing target instead of being distributed over the surface of the dosing target. Examples of such fluid dosing targets 50 include, but are not limited to, creams, gels, ointments, lotions, liquid confectioneries, or solid confectioneries in a liquid state such as melted chocolates or gelatins, beverages, and the like. For fluid dosing targets 50, the atomizing nozzle 206 and high voltage generator 212 may be dispensed with. Instead, the compartment 202 comprises a standard nozzle 216 operatively connected to the collection chamber 112. The pneumatic ram 214 then drives the compound dosing liquid 30 through the standard nozzle 216 where it is directed into the fluid dosing target 50. Alternatively, the pneumatic ram 214 may be dispensed with and the compound dosing fluid 50 may drain from the collection chamber 112 and into the standard nozzle 216, where it is directed into the fluid dosing target 50. The compartment 202 may further comprise a valve 218 interposed between the collection chamber 112 and the standard nozzle 216 to control drainage of the compound dosing liquid 30 under gravity.

In some embodiments, a second mixing device 218 is mounted on the target platform 204 in the compartment 202. The second mixing device 218 serves to mix the fluid dosing target 50 with the compound dosing liquid 30 dispensed from the standard nozzle to a desired level of homogeneity. In some embodiments, the target platform 204 comprises target temperature control elements 220 to maintain the fluid dosing target 50 at an elevated or reduced temperature, for example to prevent a fluid dosing target 50 from solidifying, or to rapidly solidify a fluid dosing target 50 after the compound dosing liquid 30 is incorporated.

Referring to FIG. 13, according to some embodiments the application apparatus 200 operates in a semi-continuous or continuous processing mode, as opposed to the batch-processing embodiments previously described. A plurality of target platforms 204 are mounted to a target conveyor 222 that passes through the compartment 202. It is preferable that only a single target platform 204 occupy the compartment 202 at one time to ensure that the full quantity of compound dosing liquid 30 coats the dosing target 40 in the compartment 202 instead of potentially being diverted to a dosing target on an adjacent target platform. After coating in the compartment 202, the target conveyor 222 may transport the coated dosing target to further processing devices such as ovens, refrigerators, freezers, packaging equipment, and the like.

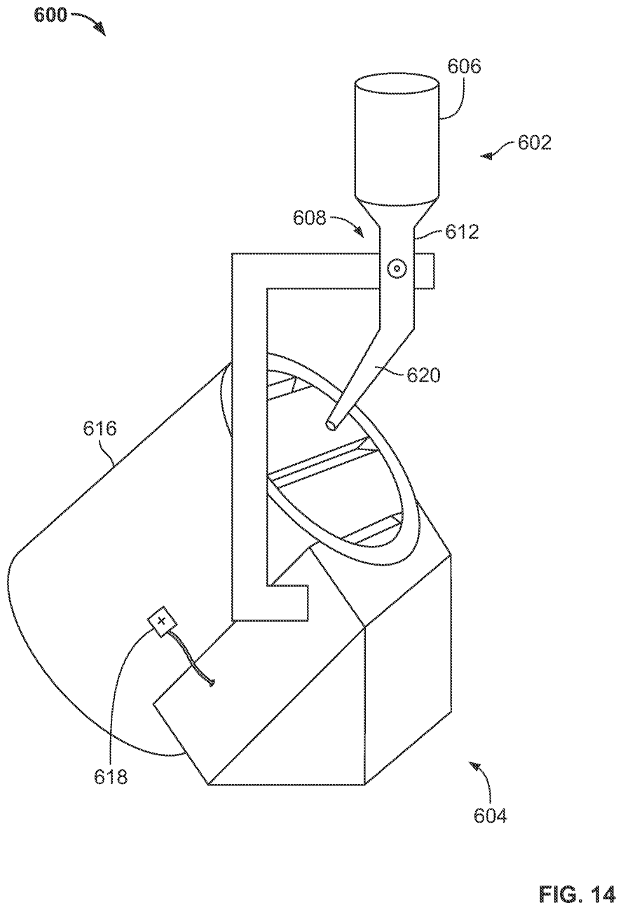

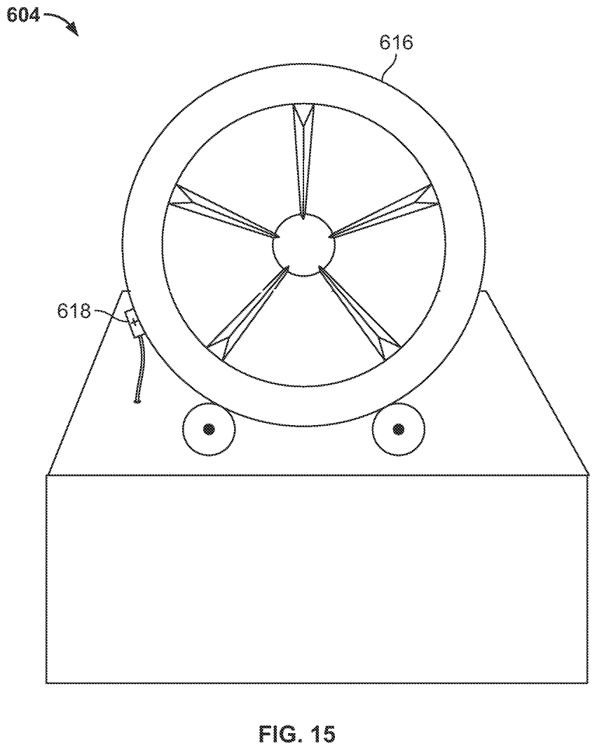

FIGS. 14-16 show another embodiment of a dosing apparatus 600 adapted to dose dosing targets with powdered additives. Suitable dosing targets will generally comprise a bulk solid, such as bulk cannabis flower, solid food items such as snack foods, and the like. Dosing apparatus 600 comprises a combining apparatus 602 and an application apparatus 604.

Combining apparatus 602 includes at least one primary hopper 606 for storing a powder additive. The powder additive may comprise a pre-mixed blend of various powdered additives or a single powdered additive. Suitable powdered additives may include, but are not limited to, cannabis powder or flour, cannabinoid oil powders, sugars or salts infused with cannabinoids, and the like.

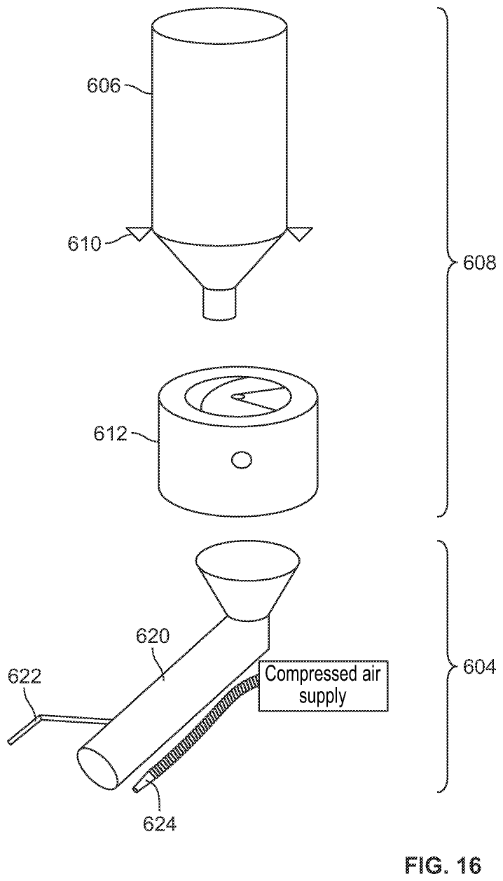

Combining apparatus 602 includes a dispensing apparatus 608 that extracts precise amounts of the powder additive from primary hopper 606. In some embodiments, dispensing apparatus 608 comprises a load cell 610 connected to primary hopper 606 and a dispenser 612 coupled to primary hopper 606. Suitable dispensers 612 may include feed screws (as shown in FIG. 16), rotary valve dispensers, and the like. Dispenser 612 is actuated to transfer the powder additive from primary hopper 606 until load cell 610 detects a change in mass of primary hopper 606 corresponding to the desired amount of the powder additive to be dispensed. Preferably, load cell 610 is capable of accurately measuring the powder additive within 1 milligram.

Application apparatus 604 comprises a rotary tumbler 616 for holding the dosing target. A first electrostatic charging device, such as an electrode 618, is in operative contact with rotary tumbler 616. Electrode 618 applies a first electric charge having a first polarity to the dosing target inside rotary tumbler 616. Rotary tumbler 616 thereby both charges the dosing target and tumbles the dosing target to expose all sides of the dosing target to the powdered additive.

Application apparatus 604 includes application means for dispensing the powder additive onto the dosing target. In some embodiments, application apparatus 604 includes a vibratory feeder pan 620 operative to transfer the powder additive from dispenser 612 into rotary tumbler 616. An electrode 622 positioned in operative contact with vibratory feeder pan 620 applies a second electric charge to the powdered additive as it leaves vibratory feeder pan 620. The second electric charge has an opposite polarity to the first electric charge applied to the dosing target, such that the powdered additive is attracted to and adheres to the dosing target. In some embodiments, application apparatus 604 includes an air knife 624 positioned at an end of feeder pan 622 that fluidizes the powder additive as it leaves vibratory feeder pan 622 for improved dispersion.

In some embodiments, combining apparatus 602 includes a plurality of dispensing apparatus 608. Each hopper of the plurality of dispensing apparatus 608 may contain a different type of powdered additive, allowing for customized blends of powdered additives similar to embodiments of the invention for fluid additives described above.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;

and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole. The specification and drawings are, accordingly, to be regarded in an illustrative rather than a restrictive sense.

1. An apparatus for applying powdered cannabis-derived additives to a product for human consumption, the apparatus comprising:
a hopper containing a powdered cannabis-derived additive;
a gravimetric dispensing device in operative connection with the hopper, the gravimetric dispensing device operative to dispense a predetermined quantity of the powdered additive to an accuracy within one milligram;
a rotary tumbler for containing and tumbling the product, the rotary tumbler including a first electrostatic charging device for applying a first electrostatic charge to the product;
an applicator assembly, the applicator assembly transferring the powdered additive from gravimetric dispensing device to the product in the rotary tumbler; and
a second electrostatic charging device in operative connection with the applicator assembly for applying a second electrostatic charge to the powdered additive;
wherein the first electrostatic charge is in opposite polarity to the second electrostatic charge.

2. The apparatus according to claim 1 wherein the applicator assembly comprises a vibratory feeder.

3. The apparatus according to claim 1 wherein the first electrostatic charging device comprises an electrode coupled to the applicator assembly.

4. The apparatus according to claim 1 wherein the product is selected from the group consisting of cannabis flowers, cannabis leaves and stems, and food items.

5. The apparatus according to claim 1 wherein the powdered additives are selected from the group consisting of dried and ground cannabis, powdered cannabis extract, powdered cannabis distillate, sugar infused with cannabis extract, sugar infused with cannabis distillate, salt infused with cannabis extract, and salt infused with cannabis distillate.

6. An apparatus for applying liquid cannabis-derived additives to a product for human consumption, the apparatus comprising:
A plurality of reservoirs, each reservoir containing a liquid additive;
one or more volumetric dispensing devices, each of said one or more volumetric dispensing devices in operative connection with at least one of the plurality of reservoirs, each of the one or more volumetric dispensing devices operative to dispense a predetermined quantity of the liquid additives to an accuracy within one millilitre;
a target chamber for containing the product;
a nozzle in fluid communication with said one or more volumetric dispensing devices, the nozzle directed at the product in the target chamber;
a first electrostatic charging device comprising a first electrode insertable in the product to apply a first electrostatic charge to the product; and
a second electrostatic charging device comprising a second electrode in operative connection with the nozzle to apply a second electrostatic charge to liquid additives expelled from the nozzle; wherein
the first electrostatic charge is opposite in polarity to the second electrostatic charge.

7. The apparatus according to claim 6, wherein each reservoir of said plurality of reservoirs contains a different additive.

8. The apparatus according to claim 6, the apparatus including a mixing chamber connected between the one or more volumetric dispensing devices and the nozzle, the mixing chamber configured to combine additives from respective ones of the plurality of reservoirs.

9. The apparatus according to claim 7 wherein each of the reservoirs comprises a syringe and each of the one or more volumetric dispensing devices comprises a linear actuator operable to depress a plunger of each respective syringe.

10. The apparatus according to claim 6 wherein the nozzle is an atomizing nozzle.

11. The apparatus according to claim 6 wherein the product is selected from the group consisting of cannabis flowers, cannabis leaves and stems, ingestible products, and topical products.

12. The apparatus according to claim 6 wherein each liquid additive comprises a carrier fluid and an additive selected from the group consisting of cannabis extracts, cannabinoid distillates, and terpene distillates.

13. A method for applying a cannabis-derived additive to a product for human consumption, the method comprising:
dispensing component parts from one or more reservoirs within 1 milligram accuracy;
mixing the component parts to form the additive;
applying a first electrostatic charge to the product;
applying a second electrostatic charge to the additive, the second electrostatic charge being of opposite polarity to the first electrostatic charge;
subsequent to applying the second electrostatic charge to the additive, applying the additive to the product.

14. The method according to claim 13, wherein at least one of the component parts is selected from the group consisting of a cannabis extract, a cannabis distillate, a cannabinoid, and a terpene.

15. The method according to claim 13, wherein each of the component parts is a powder.

16. The method according to claim 13, wherein each of the component parts is suspended or dissolved in one or more carrier fluids, each one of the carrier fluids being miscible with the other carrier fluids.

17. The method according to claim 16, the method comprising:
storing each carrier fluid containing a different component part in a different respective syringe, each syringe in fluid communication with a mixing chamber;
positioning a linear actuator over a first one of said syringes containing a first one of said component parts;
actuating, by the linear actuator, a first plunger associated with the first one of said syringes to dispense a first amount of said first one of said component parts from said first one of said syringes into the mixing chamber;
re-positioning the linear actuator over a second one of said syringes containing a second one of said component parts;
actuating, by the linear actuator, a second plunger associated with the second one of said syringes to dispense a second amount of said second one of said component parts from said second one of said syringes into the mixing chamber;
mixing the component parts in the mixing chamber to form the desired additive; and
operating a ram to force the desired additive in the mixing chamber through a nozzle in fluid communication with the mixing chamber, the nozzle aimed to dispense the desired additive on the organic substance.
